(19) United States
(12) Patent Application Publication
(10) Pub. No.: US 2006/0018024 A1
(43) Pub. Date: Jan. 26, 2006

(54) Panoramic see-through optical device

(76) Inventors: Kyle R. Bryant, Alexandria, VA (US); John M. Hall, Amherst, NH (US)

Correspondence Address: DEPARTMENT OF THE ARMY, AMSEL LG P NVEO, 10225 BURBECK ROAD, FORT BELVOIR, VA, 22060-5806, US

(21) Appl. No.: 10/896,958

(22) Filed: Jul. 23, 2004

(51) Int. Cl. G02B 27/10

(52) U.S. Cl. 359/618

(57) ABSTRACT

A panoramic see-through optical device in accordance with the present invention includes at least two prisms having a reflective face extending diagonally through the prism. Each prism has one convex surface with a tangent plane thereto, and the two prisms are arranged so that the tangent planes are orthogonal to each other. The device further includes a plurality of display panels corresponding to a respective prism. The display panels are placed about parallel to each tangent plane so that the convex surface of the prism faces the panel. An optical train, which minimally includes a filter and a surface diffractive lens, is located between the display panel and the prism, primarily to correct for chromatic aberration, or color spread. Data from each display panel can be reflected by reflective face internal to the prism and seen by the operator. At the same time, the operator can see directly through the partially reflective face of the prism. The result is a field of view with data from the display panel that is superimposed over the field of view.

### GOVERNMENT INTEREST

The invention described herein may be manufactured, used, sold, imported, and/or licensed by or for the Government of the United States of America.

### FIELD OF THE INVENTION

The present invention applies generally to optical devices. More particularly, the present invention applies to optical devices that incorporate prisms and diffractive lenses made of plastic materials, which further allows for manufacture of panoramic see-through optical devices that are extremely lightweight.

### BACKGROUND OF THE INVENTION

“See-through” display systems are those systems that are partially reflective in order to allow the user to actually see-through the display while at the same time viewing data that is being displayed by the system. Such systems allow for quicker decision-making on the part of the user, and these see-through systems are particularly advantageous for head-mounted systems such as cranials that are used in general aviation and helmets that are used in military applications.

For these systems, glass optics has heretofore been used to relay the image of a Cathode Ray Tube (flat) or similar type display panel onto a visor element. The visor element is constructed so that user can see through the visor while at the same time observing the image that is displayed on the visor surface, which is reflected into the user's eye. Visor approaches, however, limit the user field of view, and visor-type systems also tend to be limited by size and weight constraints.

To increase the system field of view (FOV) a panoramic approach is needed, and the advent of available flat panel display technology affords a different technique for display packaging. Specifically, instead of attempting to project a single display image onto the visor of a helmet, it is often more advantageous to use a plurality of display images in a tessellating fashion to yield a panoramic display of data. To do this, a plurality of see-through combiner eyepieces would be needed to provide the panoramic display. If the combiner eyepieces were made of glass, however, the weight of the panoramic display system would be excessive. What is desired is a combiner eyepiece that would take advantage of new panel display technology, in order to improve field of view coverage and simultaneously reduce overall weight.

In light of the above, it is an object of the present invention to provide an optical device that provides for panoramic see-through capability. It is another object of the present invention to provide a panoramic see-through optical device that has a reduced size and weight. Yet another object of the present invention is to provide an optical device with plastic lenses that are corrected for chromatic aberration. Still another object of the present invention is to provide a panoramic see-through device that takes advantage of advances in flat panel display by tessellating the output of a plurality of flat panel displays. It is another object of the present invention to provide a panoramic see-through optical device that is relatively easy to manufacture in a cost-effective manner.

### SUMMARY OF THE INVENTION

A panoramic see-through optical device in accordance with the present invention includes at least two combiner prisms with a somewhat cubic shape, with each prism having a partially reflective face plane extending diagonally through the prism. Each prism has one convex surface with a tangent plane thereto. Each prism defines a channel, and the two prisms are positioned next to each other so that the tangent planes are orthogonal to each other, and further so that the reflective face planes are arranged next to each other in a tessellating manner as viewed from the line of sight of a viewer.

The device further includes a plurality of image generating means corresponding to the respective combiner prisms. Preferably, the image generating means are flat display panels that are placed about parallel to and spaced-apart from each tangent plane so that the convex surface of the prism faces the panel. Data from each display panel is reflected into the prism and onto the reflective face plane. The reflective face further reflected into the prism and onto the reflective face plane. The reflective face plane further reflects the data into the field of view of the user. At the same time, the operator can see directly through the prism. The result is a field of view with data from the display panel that is superimposed over the field of view.

An optical train, which minimally includes a filter and a surface diffractive lens, is located between the display panel and the prism, primarily to correct for chromatic aberration, or color spread. In this regard, the diffractive lens is a plano-convex lens with a flat surface and an opposing curved surface. A plurality of concentric microgrooves are placed in the flat surface, and the diffractive lens is positioned so that the curved surface of the diffractive lens faces the convex surface of the prism. The number of concentric microgrooves and their linear spacing is determined according the materials properties of the diffractive lens. Preferably, the diffractive lens, the combiner prisms and the remainder of the associated optics are made of a plastic material such as Zeonex®, which is manufactured by Zeon Chemicals L.P. This allows for greatly reduced weight of the overall device of the present invention.

For the method of the present invention, the prisms having structure as described above are provided and are arranged so that the tangent planes of the respective convex surfaces are orthogonal. A display image is established at each corresponding display panel, and the display image is projected into the prism for further reflection of the reflective face. After reflection, the operator observes the display image. Simultaneously, because of the material and coatings placed on the prism, the operator can see through the prism and observe the surroundings. The result is a panoramic see-through device wherein display images are superimposed over the operator field of view.

If each prism, display panel and optical train defines a channel of approximately thirty-five degrees, the two channels can be placed in front of each eye of the operator. The result is a panoramic field of view of approximately seventy degrees, wherein display data from targeting electronics, etc. is superimposed onto the operator field of view.

### BRIEF DESCRIPTION OF THE DRAWINGS

The novel features of this invention will be best understood from the accompanying drawings, taken in conjunction with the accompanying description, in which similar characters refer to similar parts, and in which:

FIG. 1 is a front isometric view of the device of the present invention.

FIG. 2 is a front elevational view of the channels of the device of FIG. 1, as viewed by the user.

FIG. 3 is a rear elevational view of FIG. 2.

FIG. 4 is an isometric view of the optics for one channel of the device of FIG. 1.

FIG. 5 is a front elevational view of the optics of FIG. 4.

FIG. 6 is a top plan view of optics of FIG. 4.

FIG. 7 is an isometric view of the combiner prisms for the optics of FIG. 4.

FIG. 8 is an exploded isometric view of the combiner prisms of FIG. 7.

FIG. 9 is an isometric view a single combiner prism.

FIG. 10 is a front elevational view of the combiner prism of FIG. 9.

FIG. 11 is a side elevational view of the combiner prism of FIG. 10.

### WRITTEN DESCRIPTION OF THE PREFERRED EMBODIMENT

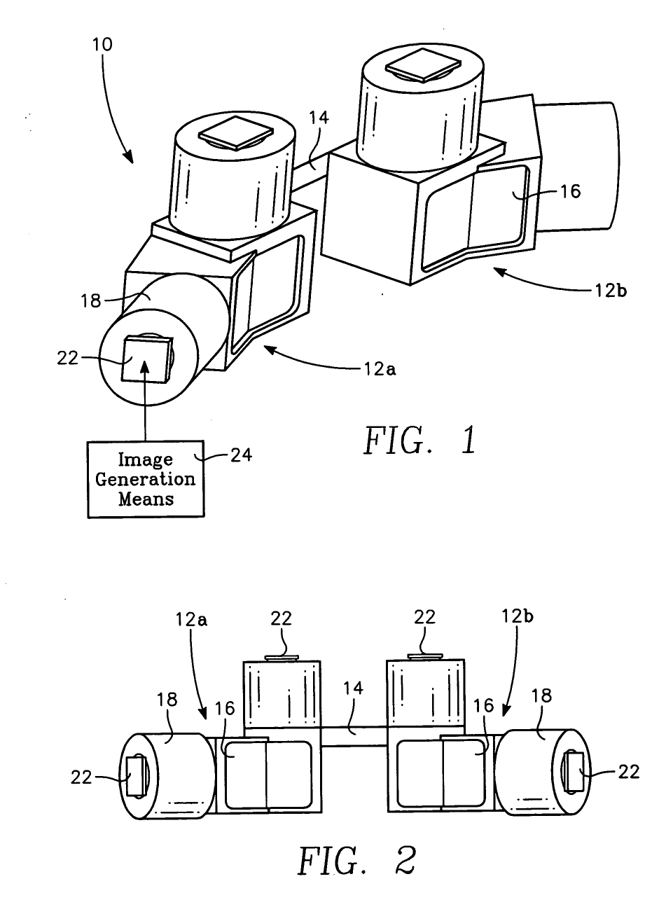

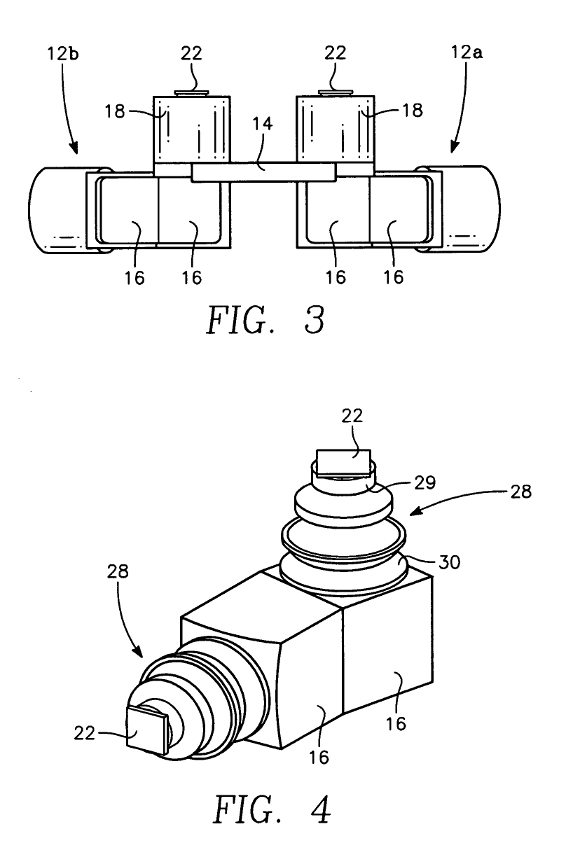

Referring initially to FIGS. 1-3, the panoramic see-through device of the present invention is shown and is generally indicated by character reference 10. As shown, the device includes two channel assemblies 12a, 12b that are fixed to mounting bar 14. The mounting bar allows for attachment of the panoramic see-through device 10 to devices such as an aviator's cranial (not shown), where it is desired that electronic data be superimposed over the viewer field of view (FOV). The channel assemblies define channels corresponding to the eyes of the viewer (not shown) and allow for a panoramic see through capability in a manner described more fully hereinafter.

Each channel assembly includes two combiner prisms 16, 16 that are fixed within housing 18. Each channel assembly further comprises two optical trains 20, 20 (See FIGS. 4-6) and display panels 22, 22 that correspond to a respective combiner prism 16. The optical trains 18, 18 are fixed within the housing, and the display panels are fixed to the outside of the housing so that an associated optical train is located between the display panel and the combiner prism. An image generation means 24, such as a camera or radar, is electronically attached to generate an image on each respective flat panel. The generated image on the flat panel is in turn reflected into its corresponding combiner prism, onto the internal face plane 26 as hereinafter described.

By cross-referencing FIGS. 1 through 4, it can be seen how the objects can be combined to provide a panoramic see-through view for the user. For purposes of this application, see-through capability is defined as the ability of the user to see data on a face of a prism while at the same time being able to see-through the prism into the normal field of view (FOV) of the user. The combiner prisms have see-through aspects. The image generations means and display panels are oriented perpendicular to each other and out of the FOV of the user. Each display panel displays data corresponding to the FOV for its respective combiner prism, which is approximately thirty (30) degrees wide. The data is superimposed of the user FOV, and for each channel, combiner prisms are arranged so that their internal face planes lie next to each in a tessellated fashion. The net result is a device having for panoramic see-through capability.

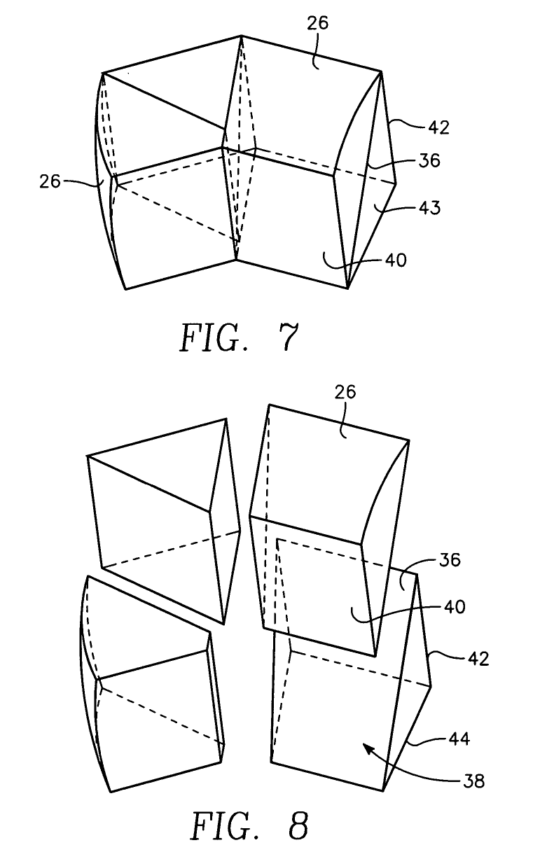

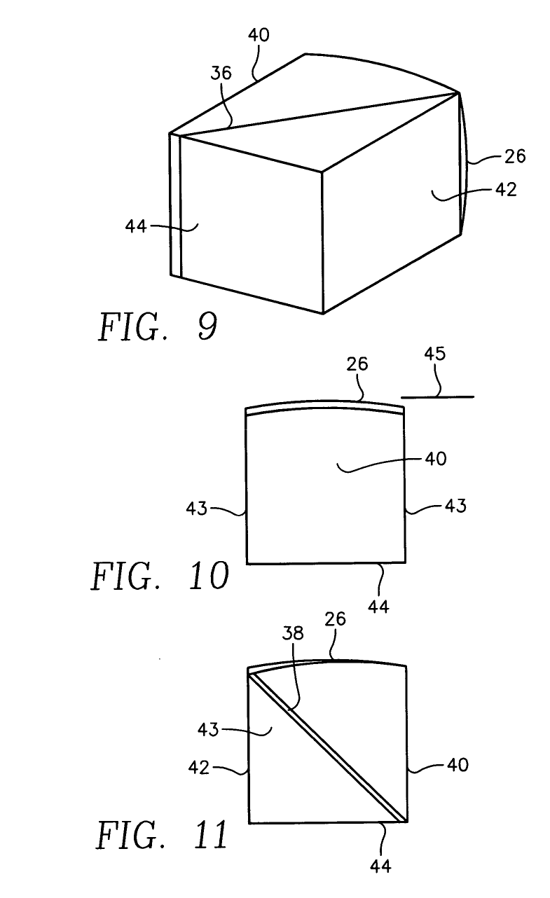

Referring now to FIGS. 4-10, the optics for the device for the present invention is shown in more detail. As shown, each channel includes the aforementioned combiner prisms. The combiner prisms are roughly cubic in shape have flat surfaces with the exception of one convex surface 26. The optical train further comprises a plurality of lenses 28 and filters 29 that are chosen according to the intended application of the device and for the manipulation of the image that is generated by image generation means 24. Importantly, the optical train includes at least one diffractive lens 30 having a convex diffractive surface 32. The diffractive surface is further formed with a plurality of concentric microgrooves 34 as depicted by FIG. 7. When the optical train is positioned between the flat panel and the combiner prism, the diffractive surface of the diffractive lens faces and is immediately proximate to the convex surface of the combiner prism, and the microgrooves formed therein correct for chromatic aberration, or color spread of a generated image within the combiner prism.

It is preferred that the combiner prism and the optical train components be made of the same materials, to minimize the diffractive aspects and further minimize the length and number of components of the optical train. For the materials of the present invention, it is also preferred that the device be as lightweight as possible, particularly in applications where the device is mounted to the aviator's cranial. Accordingly, although other plastic materials and glass material are also suitable for manufacture thereof, the combiner and optical train are preferably manufactured of a Zeonex® material manufactured by Zeon Chemicals, L.P. This allows for an extremely lightweight device, which can be mounted to the headgear and allows for greater comfort of the user and reduced pilot fatigue.

The aforementioned diffractive lens corrects color spread via incorporation of microgrooves in its diffractive surface. The number of microgrooves is varies according the refractive index of the diffractive lens, which further varies according the materials of manufacture thereof. For a combiner prism and optical made of Zeonex® materials, it is preferable that at least 700 micro groups per inch are etched in each plastic surface.

Referring now to FIGS. 8-10 the structure of the combiner prism for the device of the present invention is shown in greater detail. As shown and discussed above, the combiner prism has a polyhedral shape that is substantially cubic, with an opposing front surface 40 and back surface 42 that are substantially flat and that lie in parallel planes. Similarly, opposing side surfaces 43, 43 are substantially flat and lie in parallel planes, although it is understood that a portion of the prism could be removed so that the side surfaces are not parallel, in order to save space with the associated optical train.

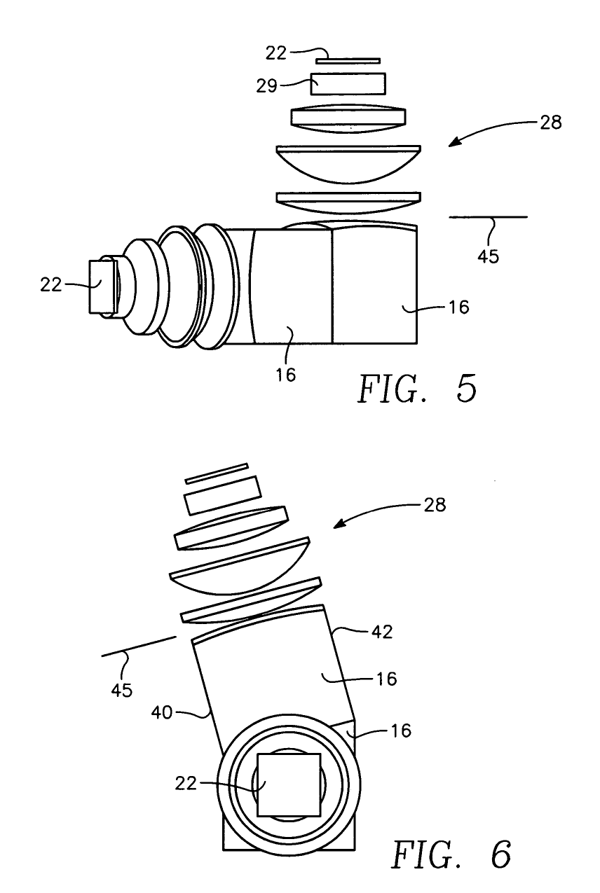

The combiner prism further includes a planar polygonal bottom surface 44 and opposing convex surface 26, as described above. The bottom surface and convex surface arranged so that the aforementioned tangent plane 45 to the convex surface is parallel to the bottom surface. By cross-referencing FIGS. 5-7, it can be seen that when two combiner prisms are arranged within channel 12, the combiner prisms are arranged so that bottom surface 44 of one combiner prism (shown in phantom in FIG. 7) contacts a side surface 43 of the other combiner prism. This further results in tangent planes 45 that are orthogonal to each other.

The combiner prism has a partially reflective internal face plane 36 that extends diagonally through the combiner prism from one edge of the bottom surface to an edge of the convex surface 26. To establish this face plane, the cubic is cut diagonally along the face plane. A partially reflective coating 38 (depicted in FIG. 11) is then placed on the diagonal surfaces that define the internal face plane in accordance with the guidelines found in Military Standardization Handbook MIL-HDBK-141, Optical Design. Next, the two half cubes are fixed together with a clear adhesive that is commercially available, such as Norland Optical Adhesive 77 (NOA 77) adhesive. Alternatively, the combiner prism can be machined so the two half cubes contact each other and there is no gap therebetween when the half cubes are placed in the housing 18.

The partially reflective coating 38 is what allows the viewer to see through the prism. At the same time, the coating reflects data from the flat panel so that the viewer can observe it. It should be appreciated that although the manner in which the coating is applied is described in the aforementioned MIL-HDBK-141, the type of coating applied is a design choice according to the needs of the user. For example, a fifty/fifty reflective coating (a coating that allows half of the light from the environment to pass through and been seen by the user). In applications where the device is used primarily in daylight, however, a seventy/thirty coating could be used, as less light needs to pass through the combiner prism due to the daylight conditions. Conversely, a thirty/seventy coating can be used where the device is to be used at night or in low light conditions and more light needs to pass through the prism to be seen by the user.

As can be seen from the Figures, the combiner prisms can be tessellated to yield a panoramic field of view that is not obstructed by the optical train components. To do this, however, and keeping in mind the optical train is needed to manipulate images from the flat panels and to correct for chromatic aberration, the combiner prism must be arranged in a specific manner. Specifically, the combiner prisms for each channel are preferably arranged so that the planes that are tangent to the convex surfaces are orthogonal. The net result is a relatively lightweight device with panoramic see-through capability.

While the panoramic see-through optical device, as herein shown and disclosed in detail, is fully capable of obtaining the objects and providing the advantages above stated, it is to be understood that the presently preferred embodiments are merely illustrative of the invention. As such, no limitations are intended other than as defined in the appended claims.

What is claimed is:

1. A optical device comprising:
an eyepiece having at least two channels, each said channel having a respective field of view;
each said channel further including a respective combiner prism with an internal face defining an internal face plane, said face plane extending diagonally therethrough; and,
said face plane being coated with a partially reflective coating for allowing a viewer to see therethrough; and,
a plurality of display panels, each display panel corresponding to a respective said channel and projecting a generated image onto said face plane for observation by said viewer, said face planes being arranged is a tessellating manner.

2. The device of claim 1 wherein said prisms are oriented so that said face planes intersect.

3. The device of claim 2 further comprising an optical train positioned between said display panel and said prism, said optical train including a filter and a diffractive lens.

4. The device of claims 3 wherein said combiner prisms and said optical train are made of a plastic material.

5. The device of claim 4 wherein said diffractive lens has a curved surface and an opposing planar surface, and further wherein said flat surface is formed with a predetermined plurality of concentric microgrooves, said plurality being predetermined according to the refractive index of said plastic material.

6. The device of claim 5 where said plastic material is Zeonex and at least 700 microgrooves per inch are etched in said diffractive surface.

7. The device of claim 1 wherein said combiner prisms each have a substantially cubic shape with one convex surface, and further wherein said convex surfaces define respective tangent planes and said tangent planes are orthogonal.

8. A method for providing panoramic see-through optics for a viewer, said method comprising the steps of:
A) providing at least two combiner prisms, each said combiner prism having a convex surface having a tangent plane;
B) establishing a diagonal face with see-through capability internal to each said combiner prism;
C) generating a respective display image corresponding to each internal face;
D) orienting said prisms so that said face planes are arranged in a tessellating manner and said tangent planes are orthogonal; and,
E) projecting each said flat panel display image onto said convex surface for further reflection by said internal face onto the panoramic field of vision.

9. The method of claim 8 further comprising the step of:
E) focusing said flat panel display image with an optical train positioned between said display image and said convex surface.

10. The method of claim 9 wherein said step E) further comprises the step of
F) correcting said flat panel display image for chromatic aberration with a diffractive surface lens.

11. The method of claim 10 wherein said steps A) and E) are accomplished with said prisms, diffractive lenses and said optical trains made of a plastic material.

12. The method of claim 11 wherein said diffractive lens has a diffractive surface, wherein said diffractive lens is made of a Zeonex® material, and further comprising the step of:
G) establishing at least seven hundred (700) grooves in said diffractive surface.

13. A panoramic see-through optical device comprising:
at least two combiner prisms;
each combiner prism having a polyhedral shape having an opposing front and back surfaces with rectangular perimeters, said front and back surfaces being arranged in parallel planes;
said combiner prism further including a opposing flat side surfaces, said side surface being flat and co-extensive in respective planes that intersect;
each prism having a flat, polygonal bottom surface and an opposing convex top surface that is polygonal when viewed in top plan; and,
said combiner prism having a reflective face plane extending diagonally therethrough from the intersection of the top surface and back surface to the intersection of the bottom surface and the front surface.

14. The device of claim 13 further comprising:
at least two display panels corresponding to each said combiner prism for projecting an image onto said reflective face plane for further reflection into a field of view;
said prism being positioned so that surface are orthogonal and said reflective faces define face planes that intersect each other.

15. The device of claims 14 further comprising an optical train positioned between said display panel and said convex surface.

16. The device of claim 15 wherein said optical train includes a diffractive lens for chromatic aberration, said diffractive lens having a curved surface and an opposing planar surface, said curved surface facing said convex surface of said combiner prism.

17. The device of claim 16 wherein said optical train, said diffractive lens and said prisms are made of a plastic material.

18. The device of claim 17 wherein a plurality of microgrooves is placed in said planar surface of said diffractive lens.
